(19) United States
(12) Patent Application Publication
(10) Pub. No.: US 2006/0019649 A1
(43) Pub. Date: Jan. 26, 2006

(54) System and method for remote telephone ringer

(76) Inventors: David A. Feinleib, Kirkland, WA (US); Caroline Moran, Preston, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/895,587

(22) Filed: Jul. 21, 2004

(51) Int. Cl. H04M 3/00

(52) U.S. Cl. 455/420

(57) ABSTRACT

A system and method for a remote telephone ringer, which when used in proximity to a wireless or non-wireless telephone rings or vibrates when the telephone itself rings or vibrates. The method includes a protocol for communicating status from a sending device to a receiving device. In response to a detected incoming call, a ringer indicator signal is transmitted from a sending device attached to or built into the phone and a receiving device. The ringer indicator signal includes an encoded status message that includes parameters that identify how the receiving device is to function in response to receiving the signal. The status message is decoded by the receiving device, and the receiving device provided corresponding indicia to indicate a phone call has been received, such as generating an audible ringing noise or vibrating. The indicia can be turned off, either through detection of motion or user input.

### FIELD OF THE INVENTION

The field of invention relates generally to a system and method for a remote telephone ringer, and more specifically, but not exclusively, to a device notified by a nearby telephone that a call is incoming. The present invention also relates to various protocols for communicating that a call is incoming, as well as for the ability to turn off the remote ringer with a single touch or movement of the device.

### BACKGROUND INFORMATION

The present invention addresses a problem encountered by just about every person at one time or another—that of the unheard phone ringer. The sequence is all too familiar. A caller desiring to reach someone at a time of critical need dials their wireless phone number. The call goes through and the callee's phone rings or vibrates, unbeknownst to the callee. The callee's wireless phone, stored in a backpack, handbag, or briefcase rings repeatedly, but the callee is unable to hear the ring or feel the vibration of the phone. Frustrated, the caller hangs up, redials the number one or more times in the hope that the callee will hear the ring but to no avail.

There are known solutions to the unheard ringer problem, but most are not viable. The callee, of course, has the option of holding the wireless phone in hand, or placing it on a table, but for a number of reasons, such as custom, inconvenience, or forgetfulness, these solutions are often unused.

The present invention addresses the aforementioned unheard ringer problem through the use of a novel remote ringing device.

### SUMMARY OF THE INVENTION

The present invention is a system and method for a remote ringer device, which when used in proximity to a wireless or non-wireless telephone rings or vibrates when the phone itself rings or vibrates.

According to one set of techniques, the remote ringer device consists of two core components. The first component is an electronic transmitting device that attaches to an existing phone. The electronic device is sensitive to ringing and vibrating sounds emanating from the phone. Upon detection of a ring or vibration, the transmitting device sends a signal indicating that a call is incoming. The second component is an electronic receiving device that receives the signal indicating an incoming call. Upon receiving the signal, the receiving device emanates a ring or vibration via a built-in ringer and/or vibrator. This receiving device is implemented in the form of a bracelet worn by the user. In another embodiment, the receiving device is implemented as a ring, an earring, a barrette, and key, a pen, and a small box that, with adhesive or via other means, attaches to an existing accessory.

According to another set of techniques, the remote ringer device consists of a chip and transmission assembly that, when integrated with the ringing circuitry of a phone, receives a signal from the phone indicating an incoming call (e.g. the same signal that is sent to the phone's own ringer/vibrator); the transmission assembly then sends a signal using Bluetooth wireless technology to a receiving device, as described above. According to another set of techniques, the transmission assembly uses Radio Frequency (RF) signals to send the incoming call signal.

According to another set of techniques, the receiving device includes a motion sensor so that, if it is in the process of ringing, and it detects movement, it will stop ringing or vibrating. The receiving device also includes a touch sensor so that if it is touched while ringing or vibrating, it will stop.

In one embodiment, the receiving device includes a sensitivity selector for adjustment of the motion and touch sensors, and a volume control knob for adjusting the volume of the ring, for switching between ring and vibrate, and for adjusting between different ring types. In another embodiment, the receiving device does not include controls, but rather receives the volume, sensitivity, and other settings as part of the novel protocol used to indicate to the receiving device that a call is incoming.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a component architecture used to send messages from the sending device to the receiving device in the form of a ring indictor signal.

FIG. 2 is a flowchart illustrating a process for setting a remote ringer device.

FIG. 3 is a flowchart illustrating operations performed by the components in component architecture of FIG. 1 in connection with receiving a phone call.

FIG. 4 is a flowchart illustrating operations in accordance with one technique via which a remote ringing device, which has been activated in response to a received ring indicator signal, can be turned off.

FIG. 5 is a flowchart illustrating operations in accordance with another technique via which a remote ringing device can be turned off.

FIG. 6 is a diagram illustrating one embodiment of the parameters in a status message used to store and transmit remote ring information.

FIG. 7 is a drawing of various devices that may be used to host embodiment of the receiving device of the present invention.

### DETAILED DESCRIPTION

Embodiments of method and apparatus for a remote telephone ringer, and more specifically, but not exclusively, a device notified by a nearby telephone that a call is incoming are described herein. In the following description, numerous specific details are set forth (such as Bluetooth indicated as the wireless technology used for communication between the devices described) to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

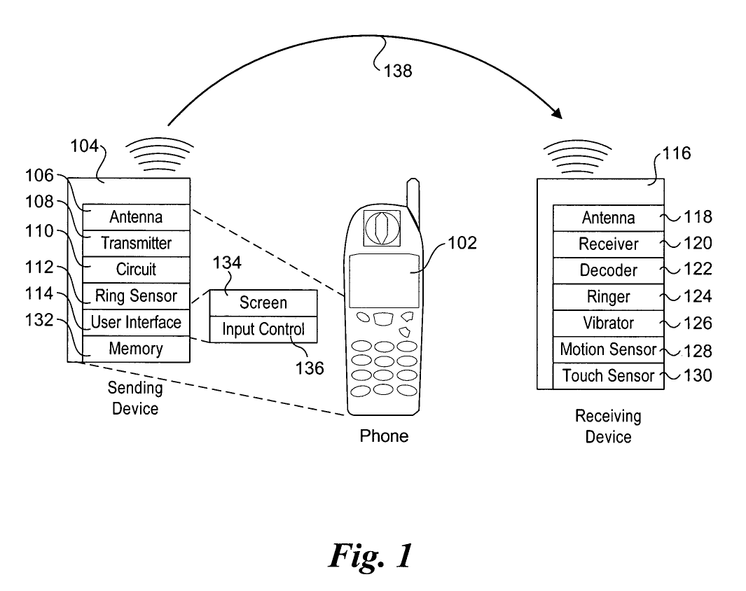

FIG. 1 shows a component architecture that supports remote ringing, according to one embodiment. The architecture includes a sending device 104 which is installed in a phone 102, such as, but not limited to, the cellular phone depicted, and a receiving device 116. Sending device 104 includes an antenna 106, a transmitter 108, a circuit 110, a ring sensor 112, a user interface 114, and memory 132. The user interface includes a screen 134 and input control 136. In response to ring of phone 102, as detected by ring sensor 112, a wireless ring indicator signal 138 is sent to receiving device 116. The receiving device includes an antenna 118, a receiver 120, a decoder 122, a ringer 124, a vibrator 126 a motion sensor 128, and a touch sensor 130.

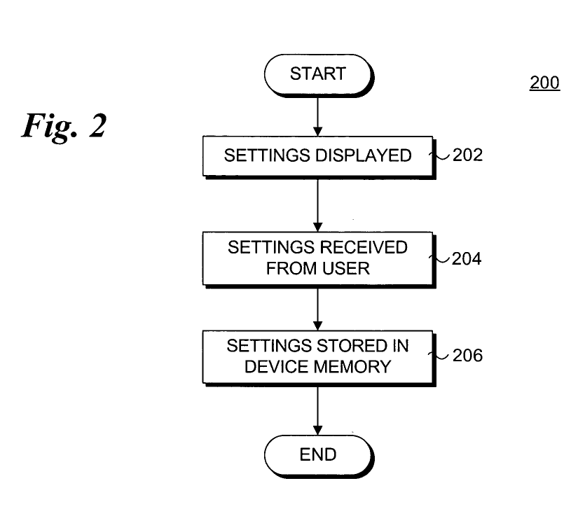

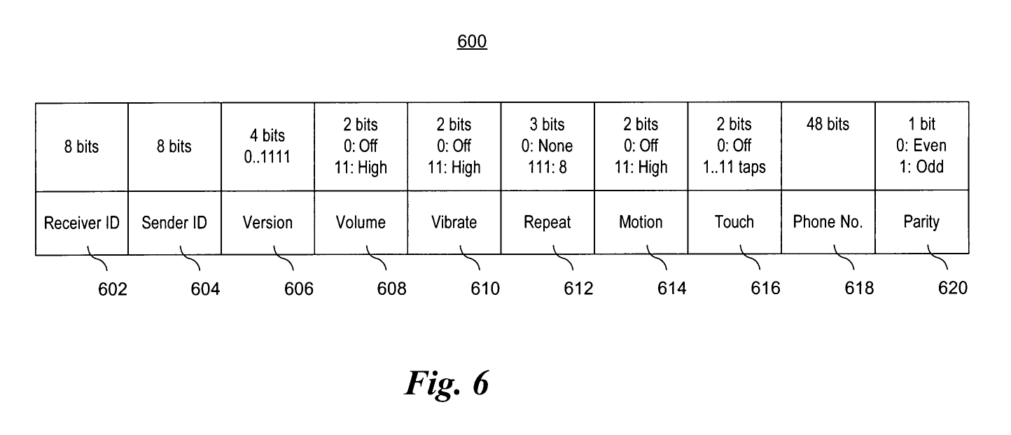

In FIG. 2, process flow 200 illustrates a process by which sending device 104 is configured by a user to set up remote ringing. The process begins in a block 202, wherein current settings are displayed on screen 134 in response to user input entered via input control 136. These settings include, but are not limited to, the settings shown in FIG. 6, which are contained as various field parameters in a status message 600, as described below. In accordance with a block 204, sending device 104 receives modified settings from the user via input control 136, displaying the revised settings on screen 134. Device 104 then stores the revised settings (e.g., corresponding to the parameters depicted in status message 600) in memory 132, as depicted in a block 206.

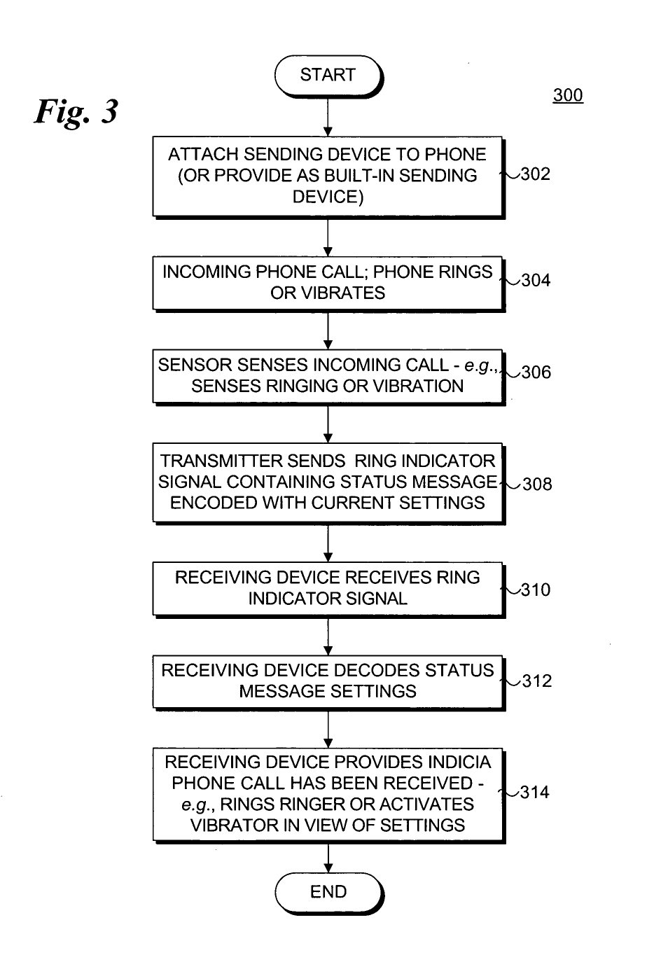

In FIG. 3, process flow 300 illustrates a process by which sending device 104 and remote receiving device 114 communicate, in which the user is ultimately notified via the remote receiving device 114 that phone 102 is ringing. In a block 302, sending device 106 is attached to phone 102. Various well-known means for attaching components may be employed, such as, but not limited to adhesives, magnetic coupling, and fasteners. As an option, the sending device may be built into phone 102. In a block 304, phone 102 receives an incoming call, causing it to ring or vibrate. In response, the ring sensor detects the incoming call in a block 306. In one embodiment, ring sensor 112 comprises a vibration sensor, which, in combination with circuit 110, detects the ringing or vibrating of phone 102 in accordance with the operations of block 306. Circuit 110 then interfaces with transmitter 108 to send a ring indicator signal 138 via antenna 106 that includes a status message with encoded parameters based on the current user settings stored in memory 132, as depicted in a block 308. In one embodiment, transmitter 108 uses Bluetooth wireless technology to transmit ring indicator signal 138. In another embodiment, transmitter 108 uses Radio Frequency (RF) signals to transmit ring indicator signal 138.

In another embodiment, sending device 104 is implemented as an integrated component of phone 102, such that circuit 110 interfaces directly with the circuitry of phone 102. Via this interface, the settings of sending device 104 can be configured (the phone's user interface is used), and ring/vibration sensor 112 is not required; the indication of ring or vibration comes directly via the phone's built-in circuitry.

Receiving device 116 is configured to sense signals sent by sending device 104 that are received via antenna 118 and receiver 120. Upon receiving a signal in a block 310, receiving device 116 decodes the incoming signal using decoder circuit 122 in a block 312, and then provides indicia indicating a phone call has been received in a block 314. For example, the receiving device may provide audio indicia, such as ringing ringer 124, or provide physical stimuli, such as via activation of vibrator 126 or providing a visual indicator. In one embodiment, the type of indicia is defined by the settings encoded in status message 600 transmitted via ring indicator signal 138.

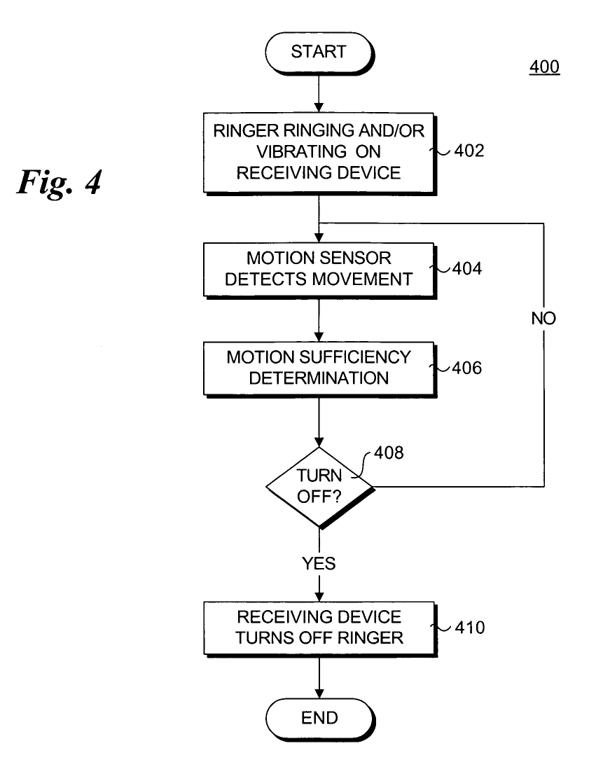

As shown in FIG. 4, one embodiment of the invention includes a novel process 400 for deactivating the ringer or vibration of receiving device 116. In one embodiment, when, due to the receipt of a notification from sending device 104, ringer 124 or vibrator 126 on receiving device 116 is activated in a block 402, motion sensor 130, integrated in receiving device 116, detects movement of the receiving device in accordance with a block 404. In a block 406, a motion sufficiency determination is performed. In one embodiment, in conjunction with decoder 122, motion sensor 130 determines whether there is sufficient movement according to a received motion setting 614 (FIG. 6) to turn off ringer 124 and/or vibrator 126. In one embodiment, motion setting 614 is 2 bit value indicating whether motion should turn off the device, and the sensitivity of the motion sensor, with 0 for no detection, 1 for low, 10 for medium, and 11 for high sensitivity. If receiving device 116 determines the ringer and/or vibrator should be turned off at a decision block 408, receiving device 116 turns off ringer 124 and/or vibrator 126 in a block 410.

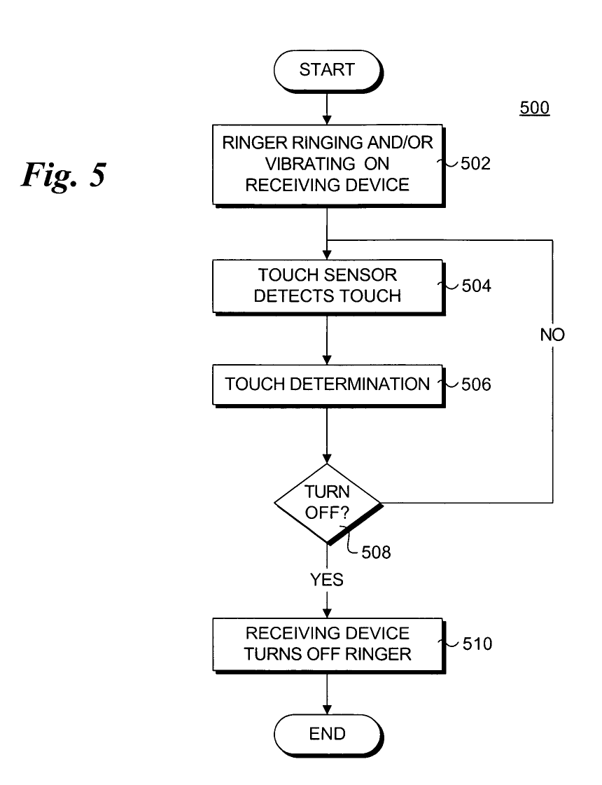

As shown in FIG. 5, in another embodiment, receiving device 116 includes a touch sensor 130 that may be employed by a user to turn of ringer 124 or vibrator 126. In accordance with a process flow 500, when ringer 124 and/or vibrator 126 of receiving device 116 is active (as depicted in a block 502) and touch sensor 130 detects a touch in a block 504, touch sensor 130 in combination with decoder circuit 122 makes a determination whether the touch is sufficient for receiving device 116 to turn off ringer 124 and/or vibrator 126, as depicted in a block 506. If the touch is sufficient, that is, if, as indicated by touch setting 516, touch sensor 130 has received sufficient taps to indicate ringer 124 and/or vibrator 126 should be turned off, as determined in a decision block 508, receiving device 116 turns off ringer 124 and/or vibrator 126 in a block 310.

As indicated earlier, FIG. 6 illustrates various fields fro a status message 600, wherein the fields contain setting values stored in memory 132 of sending device 104. In one embodiment, the parameters in status message 600 transmitted as a status message delivered via ring indicator signal 138 by sending device 104. In another embodiment, all or a portion of the parameters may be sent as a separate status message to configure the settings for receiving device 116. In the illustrated embodiment, status message 600 includes the following fields.

A receiver ID 602 is used to identify the receiver. In one embodiment, receiver ID 602 comprises an 8-bit value that contains a number identifying the receiver. In one embodiment, the value of receiver ID is set to 0 to indicate all receivers should receive the message; any other value indicates that only a receiver with the specified value should receive the message. Similarly, a sender ID 604 is used to identify the sender. On one embodiment, Sender ID 604 is an 8-bit value.

A version field 606, comprising a 4-bit value in one embodiment, is employed to indicate the version of the status message. A volume field 608 is used to indicate how the ringer volume is to be set. In one embodiment, volume field 608 comprises a 2-bit value, wherein a value of 00 indicates that the ringer volume should be off (no remote ringing should occur), 01 indicates a low volume, 10 is used for setting a medium volume, and 11 for a high ringer volume. Similarly, a vibrate field 610 is used to indicate vibration settings for receiving device 116. In one embodiment, vibrate field 610 comprises a 2-bit value, wherein a value of 00 indicates receiving device 116 should not vibrate, 01 indicates low vibration, 10 medium vibration, and 11 high vibration.

A repeat field 612 is used to indicate how many times ringer 124 and/or vibrator 126 should ring and/or vibrate. In one embodiment, wherein repeat field 612 comprises a 3-bit value, the values range from 000, meaning 0 repeats, up to 111, indicating 8 repeats.

A motion field 614 is to set the motion sensitivity level for motion sensor 128. In one embodiment, motion field 614 comprises a 2-bit value, wherein a value of 00 indicates no motion detection is to be employed, 01 indicates low motion sensitivity, 10 medium sensitivity, and 11 high sensitivity.

A touch field 616 indicates whether receiving device 116 should turn off based on a touch from the user. In one embodiment, touch field 616 comprises a 2-bit value, with 00 indicating a touch sensed by touch sensor 130 will not turn off receiving device 116, 01 indicating one tap of touch sensor 130 to turn off, 10 indicating two taps, and 11 indicating three taps.

A phone No. field 618, comprising a 48-bit field in one embodiment, is used to identify the incoming phone number, e.g. the Caller ID of the incoming call. In one embodiment, when receiving device 116 receives the status message 600, it displays the value from Phone No. field 618 on a built in Liquid Crystal Display (LCD).

A parity field 620 comprises a 1-bit field indicating the total number of set bits in all other fields. If the number of set bits is even, sending device 104 sets parity field 618 equal to zero; if odd, it sets parity field 518 to one. Receiving device 116, via decoder 122, evaluates the parity status message 600 to make sure that the set bits in all fields except parity field 620 corresponds to parity field 620. If they do not correspond, receiving device 116 knows that an error occurred during transmission and discards the message and does not ring or vibrate.

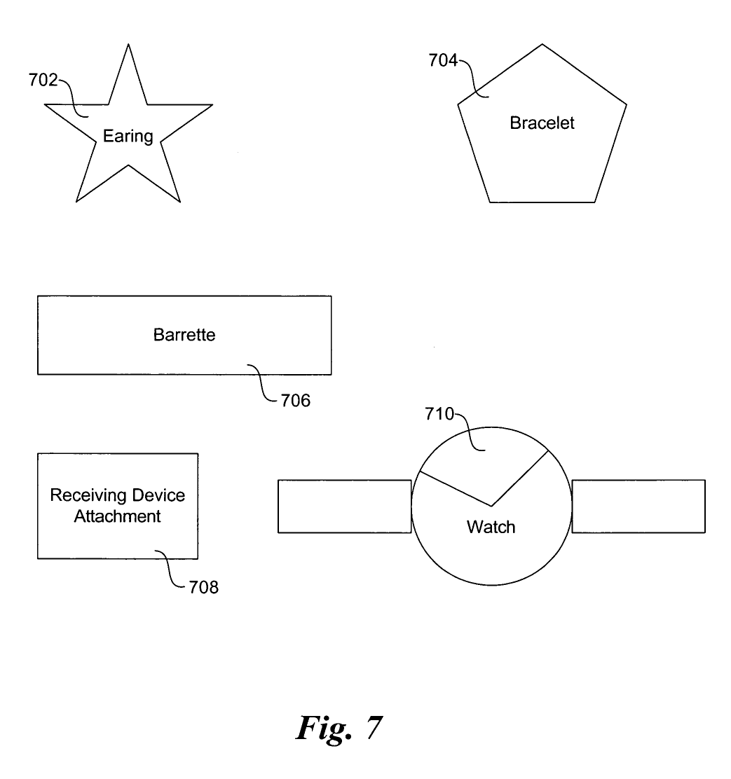

In general, receiving device 116 can be configured as a small device that can be integrated into or hosted by a variety of devices. For example, some exemplary devices are shown in FIG. 7, including an earring 702, a bracelet 704, a barrette 706, a standard adhesive receiving device, e.g. a small box with adhesive material on it that attaches to another accessory such as an existing watch or barrette, and a wristwatch 710. It will be recognized by one skilled in the art that the technology and processes of receiving device 116 can be implemented in a variety of forms.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
detecting, via a sending device, a phone call received at a phone;
transmitting a ringing indicator signal from the sending device to a remote receiving device via a wireless signal; and
providing indicia at the remote receiving device to indicate the phone has received a phone call.

2. The method of claim 1, wherein detecting that a phone call is received at the phone comprises detecting that the phone is ringing.

3. The method of claim 1, wherein detecting that the phone call is received at the phone comprises detecting that the phone is vibrating.

4. The method of claim 1, wherein the indicia at the remote receiving device used to indicate the phone has received a phone call comprise audible indicia.

5. The method of claim 2, wherein the indicia at the remote receiving device used to indicate the phone has received a phone call comprise a vibration.

6. The method of claim 1, further comprising:
enabling a user of the phone to store configuration settings in the sending device.

7. The method of claim 1, further comprising:
turning off the indicia at the remote receiving device to indicate the phone has received a phone call.

8. The method of claim 7, further comprising:
turning off the indicia at the remote receiving device in response to detection of motion at the remote receiving device.

9. The method of claim 8, further comprising:
enabling a user to pre-define the level of motion that is to be met or exceeded prior to turning off the indicia.

10. The method of claim 7, further comprising:
turning off the indicia at the remote receiving device in response to a user input to the receiving device.

11. The method of claim 10, further comprising:
enabling a user to specify the user input used to turn off the indicia.

12. The method of claim 1, wherein the ringing indicator signal is sent as a Bluetooth signal.

13. The method of claim 1, wherein the ringing indicator signal is sent as a radio frequency (RF) signal.

14. The method of claim 1, wherein the sending device is integrated into the phone.

15. The method of claim 1, wherein the sending device is attached to the phone.
